(19) United States
(12) Patent Application Publication
(10) Pub. No.: US 2012/0068943 A1
(43) Pub. Date: Mar. 22, 2012

(54) Method and Electronic Device for Retrieving Geographic Information

(75) Inventor: Chunwei Wang, ChuPei (TW)

(73) Assignee: MStar Semiconductor, Inc., ChuPei (TW)

(21) Appl. No.: 13/152,037

(22) Filed: Jun. 2, 2011

(30) Foreign Application Priority Data
Sep. 16, 2010 (TW) 099131452

(51) Int. Cl. G06F 3/041

(52) U.S. Cl. 345/173

(57) ABSTRACT

Various embodiments of a battery detector are provided. In one aspect, a method for capturing geographic information is applied to an electronic device in communication with the Global Positioning System (GPS). The method includes displaying map information on a touch screen provided by the electronic device; receiving a query condition according to an operation of a user; detecting via the touch screen a touch instruction performed by the user, with the touch instruction being corresponding to a selection range formed by at least one touch point, on the touch screen, selected by the user; querying a geographic database according to the query condition and the touch instruction; and displaying the query result on the touch screen.

### CROSS-REFERENCE TO RELATED PATENT APPLICATIONS

This patent application claims priority to Taiwan, R.O.C. Patent Application No. 099131452 filed on Sep. 16, 2010, which is herein incorporated in its entirety by reference.

### BACKGROUND

1. Technical Field

The present disclosure relates to a method and electronic device for retrieving geographic information, and more particularly, to a method and electronic device for retrieving geographic information by detecting a touch instruction conducted by a user through a touch screen.

2. Description of Related Art

As applications of the Global Position System (GPS) develop day by day, associated positioning functions increase usage conveniences. When the GPS provides positioning information, although a location of a user is found, the user can only retrieve single-position information but still lacks for overall information around ambient area. Therefore, a geographic database for providing above overall information is needed. For instance, when a conventional positioning system and device provides geographic information to a user through a pre-built associated geographic database, results matching with an inputted query in the conventional positioning system are displayed on a screen through visual presentation such as a table or a figure.

Although the foregoing implementation provides selecting/querying functions and query results of capturing the geographic information, disadvantages containing in the implementation, described in detail below, may cause inconveniences to the user in operations.

To operate this implementation properly, the user needs to have basic cognition about his location, e.g., the user needs to know his position additionally and enters his position as the query of the geographic database at first. For example, when the user would like to know if there is a gas station near by the position he located at, the user has to enter a characteristic parameter to define searching area; however, in the case that the user does not know his relative position, correspondingly, the user is not capable of defining the associated query condition into the geographic database.

Furthermore, for the user located between two administrative districts on a map, it is inconvenient to query the geographic database to gain proper geographic information due to limited classification manners for querying search areas predefined in the conventional system. In detail, when a user, located just at the boundary between district A and district B, queries a condition in the conventional system for searching locations of gas stations in the neighborhood, information the user care most is the locations of gas stations nearby a range closing to his current position, but not total information regarding to all gas stations distributing within the districts A and B. However, under conventional design approach, the user may assume that he is still within the district A (or district B) so as to query the district A (or B) as a search range to search for gas stations in the district A (or B) only. Therefore, it may cause the result that the user selects a destination far from a nearest gas station for fueling. In the end, only after searching the district B (or A) one by one at the same condition as well, the user would find that there is a gas station, in the district B (or A), only 200 meters from his position in the end.

It can be found that when the GPS is applied in association with the geographic database, although a basic data search function is provided to the user, apparently, disadvantages of such inconvenient and non-intuitive operation environment in conventional system exist. Accordingly, a solution is in need to overcome the disadvantage of lacking humanization of the current GPS.

### SUMMARY

One aspect of the present disclosure is to provide a method for retrieving geographic information for an electronic device communicatively coupled to the GPS. The method comprises below steps: displaying map information on a touch screen of the electronic device; receiving a query according to an operation of a user; detecting a touch instruction conducted by the user on the electronic device from a touch screen, the touch instruction is generated according to a selected range defined from at least one touch point selected by the user on the touch screen; querying a geographic database according to the query and the touch instruction; and displaying a query result on the touch screen.

Another aspect of the present disclosure is to provide an electronic device providing a function of retrieving geographic information via a GPS. The electronic device comprises a receiving unit, communicatively coupled to the GPS, receiving positioning information; a touch screen, electrically connected to the receiving unit, displaying map information and detecting a touch instruction conducted by a user, with the touch instruction according to a selected range defined from at least one touch point selected by the user on the touch screen; and a control unit, electrically connected to the touch screen, querying a geographic database according to the touch instruction and a query retrieved according to an operation of the user, and displaying a query result on the touch screen.

### BRIEF DESCRIPTION OF THE DRAWINGS

Following description and figures are disclosed to gain a better understanding of the advantages of the present disclosure.

FIG. 1 is a flow chart of a method for retrieving geographic information applied to an electronic device in accordance with an embodiment of the present disclosure.

FIG. 2 is a block diagram of an electronic device having a geographic information retrieving function in accordance with an embodiment of the present disclosure.

FIG. 3a, FIG. 3b and FIG. 3c are schematic diagrams of a touch instruction conducted by a user on a touch screen in accordance with an embodiment of the present disclosure.

FIG. 4a to FIG. 4e are schematic diagrams of geographic information display and corresponding storage formats of an electronic device in accordance with an embodiment of the present disclosure.

### DETAILED DESCRIPTION OF THE PREFERRED EMBODIMENTS

In order to solve the problem that a query interface is inconvenient when geographic information is received through a conventional GPS and associated device, a method for retrieving geographic information is provided. Above method is capable of implementing to an electronic device communicatively coupled to the GPS, so that a corresponding touch instruction is detected from a touch screen of the electronic device according to an intuitive gesture conducted by a user.

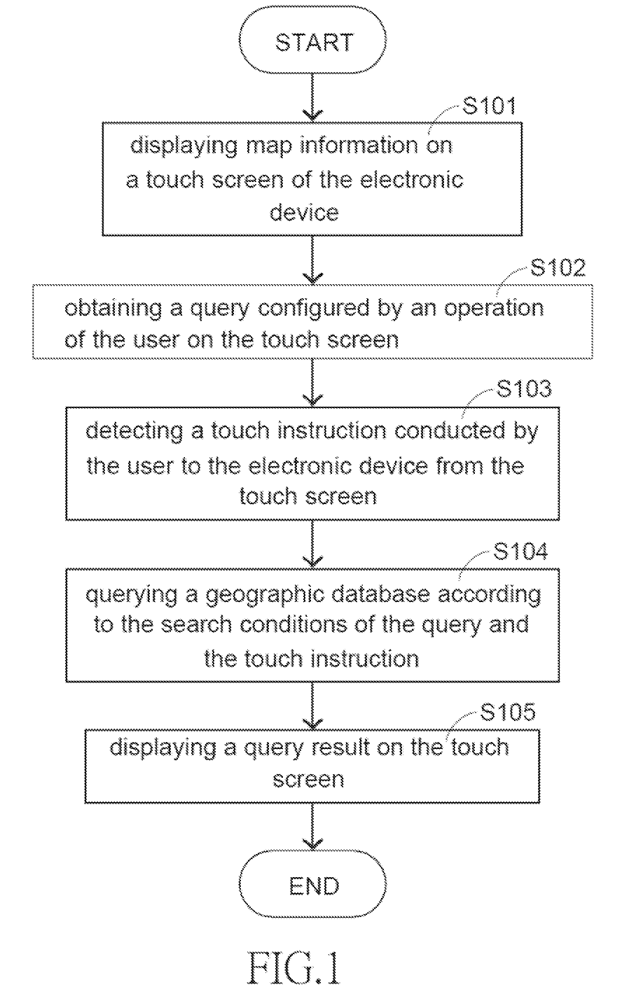

FIG. 1 illustrates a flow chart of method for retrieving geographic information implemented to an electronic device according to an embodiment of the present disclosure. A flow of a method for retrieving the geographic information is generally described below, followed by details of main steps.

In Step S101, map information is displayed on a touch screen of the electronic device. In Step S102, a query configured by an operation of the user on the touch screen is received, e.g., the search condition of the query can be locations of a gas station, a restaurant or a convenience store. In Step 103, a touch instruction conducted by the user to the electronic device according to associated positioning information is detected from the touch screen. In Step S104, after the query and the touch instruction are received, a geographic database is queried according to the search conditions of the query and the touch instruction. In Step S105, a query result is displayed on the touch screen.

In Step S102, for receiving the search condition of the query according to the configuration of the user, the electronic device provides different input or configuration approaches for the user via implementation of various input interfaces, e.g., the user can inputs the search condition of the query through an audio approach or a hand-writing approach. In one embodiment, predetermined selection lists pre-built in the electronic device are provided to the user for configuring the query condition.

In Step S103 and Step S104, i.e., after the touch instruction is detected from the touch screen, the geographic database is queried in accordance with the search condition of the query defined by the user in Step 102. It should be noted that Step S102 and Step S103 are available to be conducted in a sequence different from the foregoing disclosed. The touch instruction is a selected range formed by at least one touch point, selected by user, on the touch screen.

It is noted that, in Step S103, the step of detecting the touch instruction of the user through the touch screen is that, when the user intuitively and randomly operates the touch screen through different gestures, the touch screen detects a selected range defined by the gestures at first. After retrieving information relating to pixels of the touch screen included in the selected range, the information relating to pixels of the touch screen is transformed as the search condition of the query corresponding to an area on the map information displayed in the touch screen through a software application.

The selected range formed by at least one touch point on the touch screen according to the user intuitive gestures, for exemplary but not limitation, can be a linear segment range, a bulk/planar block range or combinations thereof, e.g., when the user randomly selects a plurality of touch points on the touch screen, an irregular area constructed by the touch points are defined as the bulk block range. Moreover, the selected range, on the touch screen formed in response to the user gestures, can be directly selected by the user, or is alternatively defined by an engaging software application to assist the user for constructing a more precisely selected range.

Possible modifications of system implementation are defined according to user requirements. For example, for achieving the step of querying the geographic information, directly implementing the built-in function of the electronic device to query the geographic information can be one solution, and transmitting information of the search condition of the query and the touch instruction to a network system or a mobile communication system communicatively coupled to the electronic device and queries the geographic information through servers in above systems can be another, for exemplary but not limitation.

In other words, for achieving above function, the electronic device can directly provide querying function of the geographic information by building the geographic database in an electronic component itself such as a memory card, or the electronic device can accesses the geographic database through the network system communicatively coupled to the electronic device to achieve above geographic information querying function. Therefore, direct implementation or indirect implementation for providing the query result through accessing the geographic data base are both practicable so that, according to at least one embodiment of the present disclosure, the flexibility of designing a proper system under different design conditions is increased.

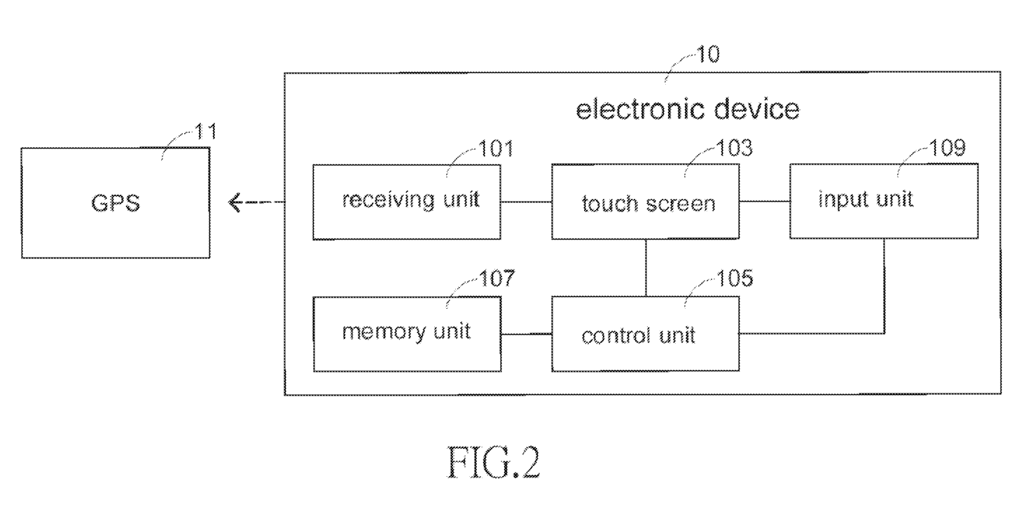

Referring to FIG. 2, a block diagram of an electronic device having a geographic information retrieving function in accordance with an embodiment of the present disclosure is illustrated. An electronic device 10 provides the geographic information retrieving function through a communicatively-coupled GPS 11. The electronic device 10 mainly comprises a receiving unit 101, communicatively coupled to the GPS 11, receiving positioning information relating to a position of a user, a touch screen 103, electrically connected to the receiving unit 101, displaying map information around the position of the user and detecting various types of touch instructions conducted by the user on the electronic device 10; and a control unit 105, electrically connected to the touch screen 103, receiving a query according to an operation of the user, querying a geographic database according to the query and the touch instruction, and displaying a query result on the touch screen 103.

According to the present disclosure, the touch instruction conducted by the user according to an intuitive gesture is detected on the touch screen 103, so that the touch instruction of the user is correspondingly converted as a selection range formed by at least one touch point on the touch screen, and the selection range is further converted to a corresponding query. Alternatively, the user is also allowed to enter the query through an input unit 109 electrically connected to the touch screen 103 and the control unit 105. In this embodiment, the query is entered through an audio approach, a hand-writing approach or in association with selection conditions displaying on the touch screen to provide a predetermined selection list to the user for selecting an associated query.

Under above discloses, the user can retrieve a matched geographic information through an intuitive way by defining the query and facilitating the geographic database by the touch instruction. The step of querying the geographic database is only disclosed as an exemplary, but not limitation, i.e., it is practicable to directly provide the query function by the electronic device 10 after the query entered by the user is received, or to associate to provide the query function from a server with geographic database communicatively coupled to the electronic device 10.

In other words, since approaches of the geographic database and a device for providing the query function do not affect the performance of the main steps of the present disclosure, the geographic database provided from a network system (not shown) communicatively coupled to the electronic device or by the electronic device 10 are both acceptable for implementing the query function. When the geographic database is provided by the electronic device 10 directly, in association with a memory unit 107 electrically connected to the control unit 105, the electronic device 10 directly provides the control unit 105 to the geographic database so as to increase accessing performance of the geographic information retrieving function.

It should be noted that the foregoing two types of approaches of the geographic database are able to be implemented together according to system capability and design requirements. For example, when a geographic database comprising a home or a working location of the user is stored in the memory unit 107, a geographic query result can be rapidly provided to the control unit 105; Once the position of the user is out of an area corresponding to the predetermined geographic database, the network system (not shown) would substitute for the predetermined geographic database as the source for providing relating geographic information.

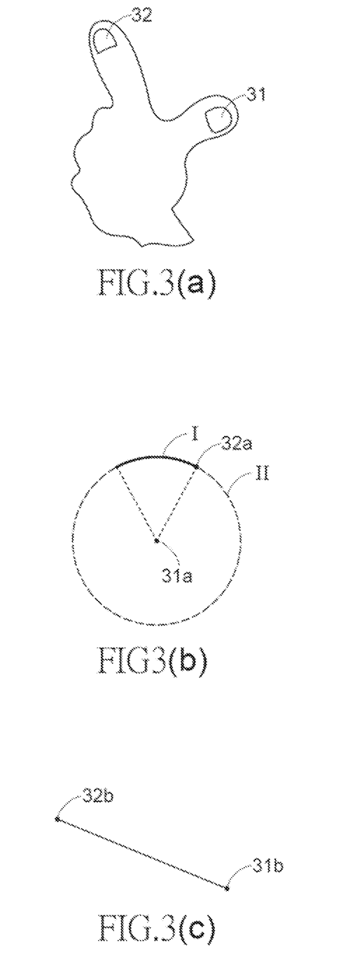

FIG. 3a, FIG. 3b and FIG. 3c illustrate schematic diagrams of a touch instruction conducted by a user on a touch screen in accordance with an embodiment of the present disclosure. It is noted that, modifications of associate applications and operation manners are practicable in an electronic device and not beyond the spirit and scope of the present disclosure.

Referring to FIG. 3a, a thumb 31 and a forefinger 32 of the user are defined as touch sources detected by the touch screen 103 when the electronic device 10 is operated. Referring to FIG. 3b, the user draws an arc with his forefinger 32. The center of arc I is defined at a touch point 31a touched by user's thumb 31. In the other words, the user selects a first touch point 31a and a second touch point 32a with his thumb 31 and his forefinger 32 respectively, and draws an arc range having its center at the first touch point 31a defined by his thumb 31 and its radius as the distance between the first touch point 31a and the second touch point 32a. Accordingly, a sector pattern according to the arc range and the center represented by the first touch point 31a. is defined.

When the foregoing operation is detected on the touch screen 103, application software in a control unit dynamically simulates and extends the arc range to extend the sector pattern to a circle pattern, and a block range, on the touch screen, correspondingly representing the circle pattern is defined as a touch instruction. In other words, through operations of software, the arc I drawn by the user is associated with another arc II to display a complete circle defined as a selection range defined by the touch instruction of the user.

Similarly, referring to FIG. 3c, the user touches a first touch point 31b with his thumb 31 and a second touch point 32b with his forefinger 32 manually. A segment range from the first touch point 31b to the second touch point 32b on the touch screen 103 is defined as a touch instruction. The touch instruction is transmitted to the control unit 105 as a parameter in querying processes. In association with a query defined by the user, the control unit 105 is capable of querying matched query results from sections of map information database corresponding to the segment range.

In addition, in order to provide a search function, an electronic device having the function for retrieving geographic information can processes map information and relating information of a search target respectively, i.e., a map frame display and relating geographic information are respectively stored. Thereafter, map information and geographic information are linked through a data mapping approach.

In some instances, according to differences of population density, instead of being distributed at a flat distribution, search targets such as convenience stores or gas stations may distribute in a concentrative or a dispersive manner. Accordingly, optimization for data structure is performed by rearranging a data structure of the geographic information database in accordance with the distributing characteristics of the search targets so as to accelerate search processes.

In one embodiment, a displaying area of the touch screen is divided into grid line sections. When the user queries geographic information, grid line sections relating to the touch instruction conducted by the user are retrieved from the touch screen at first. Thereafter, the grid line sections relating to the touch instruction are used as indexes for querying the geographic database.

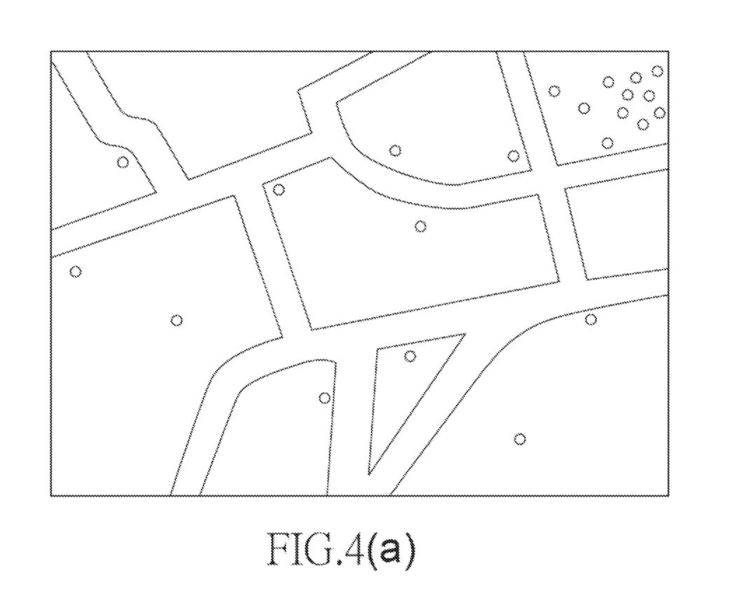

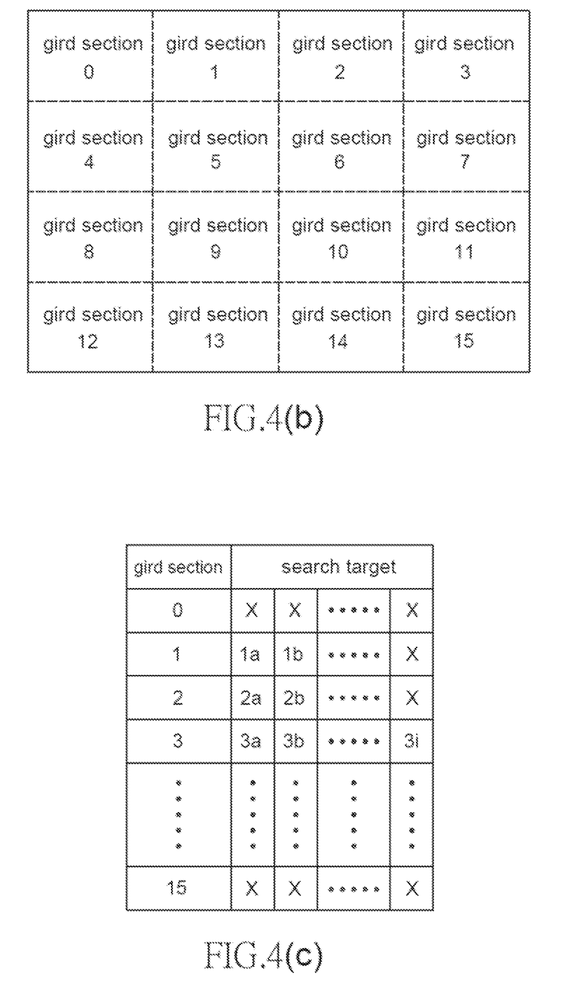

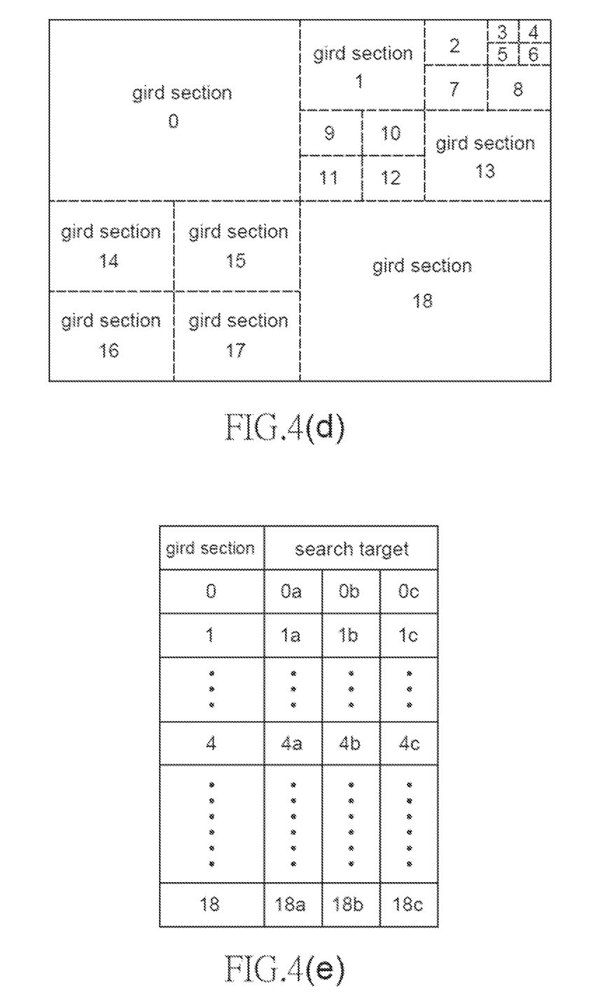

Referring to FIG. 4a to FIG. 4e, FIG. 4a to FIG. 4e are schematic diagrams illustrating storage formats corresponding to geographic information data structure of an electronic device in accordance with an embodiment of the present disclosure. Referring to FIG. 4a, it's shown that search targets are not symmetrically distributed on a map. When such imbalanced distribution situation is appeared on a system which is divided by uniform-distributed gird sections as shown in FIG. 4b, spaces for data storage may be wasted for the reason that the distribution states of search targets within each grid sections are apparently not equal to each other. In other words, if a table is constructed in a storage as illustrated in FIG. 4c under an equally divided rule, it's quite possible to waste storage since some grid sections may contain no search target at all.

Therefore, an alternative implementation for storing data of the geographic database is disclosed in another embodiment of the present disclosure illustrated in FIG. 4d. Referring to FIG. 4d, map information displayed on the touch screen 103 corresponds to a plurality of grid areas having different areas according to display ranges, e.g., it's defined as grid areas 0, 1, 2, . . . , 18. Since the grid areas have different areas, for identifying purposes, above numerical parts also represent corresponding grid areas. Under above arrangement, search targets and its corresponding geographic information are converted into a formation with more flat data density then stored. In this embodiment, with corresponding geographic information respectively, the search targets corresponding to the grid areas are stored as data index formation in the geographic database.

In other words, when the geographic database is built, geographic information can be implemented by divided area into grid areas with different areas to reflect the distribution state of search targets in real. Therefore, although the size of the grid area 4 is only 1/64 of that of the grid area 0, the grid areas 0 and 4 have the same number of search targets (e.g., gas stations). It means search targets are distributed in the grid area 4 in a more concentrated manner than those distributed in the gird area 0, i.e., the distribution density of the search targets distributed in the grid area 4 is higher than that of the search targets distributed in the grid area 0.

It should be noted that information about how to display geographic data and data structure of geographic data relating to the geographic database can be implemented through other implementations different from the approach of dividing map information into the grid areas. In other words, arrangements of the geographic information and mapping relationships of data contents are extremely diversified, and different data search approaches can be implemented to accelerate geographic information capturing, which refers to modifications of query applications of systems and shall not be described for brevity.

According to at least one embodiment of the present disclosure, when a user is located at the boundary between the area A and the area B, The user can only defined his position as a center, (e.g. select the touch point 31a as marked in FIG. 3b), and selects a selection range defined by a plurality of touch points selected by the user's forefinger. Therefore, the user can rapidly retrieve information of gas stations around his position.

In conclusion, according to at least one embodiment of the present disclosure, when a user defines a query, an electronic device having a geographic information retrieving function facilitates the user to enter a query on a touch screen through different gestures or touch motions when he observes a map, so as to provide an intuitive operation approach to the user for conveniently retrieving geographic information that meets his requirements from a geographic database.

While the present disclosure has been described in terms of what is presently considered to be the most practical and preferred embodiments, it is to be understood that the present disclosure needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for retrieving geographic information, applied to an electronic device communicatively coupled to a global positioning system, the method comprising:
displaying map information on a touch screen of the electronic device;
receiving a query according to an operation of a user;
detecting a touch instruction from the touch screen, the touch instruction indicative of a selection range defined by at least one touch point selected by the user on the touch screen;
querying a geographic database according to the query and the touch instruction; and
displaying a query result on the touch screen.

2. The method of claim 1, wherein receiving the query according to the operation of the user comprises receiving the query through an audio approach, receiving the query through a hand-writing approach, or providing a predetermined selection list to the user for selecting the query.

3. The method of claim 1, wherein the selection range comprises a segment range or a block range.

4. The method of claim 3, wherein detecting the touch instruction from the touch screen comprises:
detecting a first touch point and a second touch point selected by the user on the touch screen;
selecting an arc on the touch screen by defining the first touch point as a center of the arc and a distance between the first touch point and the second touch point as a radius of the arc; and
extending the arc to a block range as the touch instruction.

5. The method of claim 3, wherein detecting the touch instruction from the touch screen comprises:
receiving a first touch point and a second touch point as manually touched by the user on the touch screen; and
selecting a segment range defined by the first touch point and the second touch point as the touch instruction.

6. The method of claim 1, wherein querying the geographic database according to the query and the touch instruction is conducted by the electronic device or by a server communicatively coupled to the electronic device.

7. The method of claim 1, wherein the geographic database is provided from the electronic device or a network communicatively coupled to the electronic device.

8. A geographic information retrieving electronic device, comprising:
a receiving unit, communicatively coupled to the Global Positioning System (GPS), that receives positioning information;
a touch screen, electrically connected the receiving unit, that displays map information and detects a touch instruction of a user, the touch instruction indicative of a selection range defined by at least one touch point on the touch screen according to an intuitive operation of the user; and
a control unit, electrically connected to the touch screen, that queries a geographic database according to a query and the touch instruction to cause a query result to be displayed on the touch screen.

9. The electronic device of claim 8, wherein the electronic device queries the geographic database through the control unit or a server communicatively coupled to the receiving unit according to the query and the touch instruction.

10. The electronic device of claim 8, wherein the geographic database is provided from a network system communicatively coupled to the receiving unit.

11. The electronic device of claim 8, wherein the electronic device further comprises:
a memory unit, electronically connected to the control unit, that provides the geographic database for the control unit.

12. The electronic device of claim 8, wherein the electronic device further comprises:
an input unit, electrically connected to the touch screen and the control unit, that receives the query through an audio approach or a hand-writing approach, or provides a predetermined selection list to the user for selecting the query.
